(19) United States
(12) Patent Application Publication
(10) Pub. No.: US 2023/0400033 A1
(43) Pub. Date: Dec. 14, 2023

(54) Condition Monitoring Method for Pump Assembly, and Power Converter System for Pump Assembly Utilizing Said Method

(71) Applicant: ABB Schweiz AG, Baden (CH)

(72) Inventors: Santeri Pöyhönen, Lappeenranta (FI); Jero Ahola, Lappeenranta (FI); Markku Niemelä, Lappeenranta (FI)

(21) Appl. No.: 18/327,987

(22) Filed: Jun. 2, 2023

(30) Foreign Application Priority Data
Jun. 14, 2022 (EP) 22178814.4

(51) Int. Cl. F04D 27/00; F04D 15/00

(52) U.S. Cl. CPC F04D 27/001; F04D 15/0088

(57) ABSTRACT

A condition monitoring method for a pump assembly, wherein the method includes estimating a large number of system curves for the pump assembly over a long period of time in order to detect a change in an operating state of the pump assembly for assessing whether the pump assembly requires maintenance. The method includes a curve fitting procedure, in which estimated system curves are fitted on operating point data of the pump assembly. The curve fitting procedure includes providing estimated system curves for a plurality of fitting time windows, wherein each of the plurality of fitting time windows includes a plurality of operating points of the pump assembly.

### TECHNICAL FIELD

The present invention relates to a condition monitoring method for a pump assembly, and to a power converter system for a pump assembly utilizing the method.

### BACKGROUND

Pumps are a significant energy consumer in the industrial sector. In addition, they are in many cases a vital part of a greater process, and their failure can lead to costly stoppages. Ensuring the energy efficiency and reliability of pumps through monitoring and maintenance is therefore an important goal in many industrial systems.

A system to which a pump supplies flow, comprising for example piping, heat exchangers, valves, tanks, and other components, can be mathematically described by a total head vs. flow rate curve, hereinafter referred to as simply system curve. It defines the total head loss of the system surrounding the pump at different flow rates. The system curve contains information on the static pressure difference between the suction and discharge sides of the pump, which relates directly to surface levels in reservoirs and tanks connected to the pump. As another parameter, it includes a measure of the flow resistance of the system. Moreover, when also a characteristic performance curve of the pump supplying flow to the system is known, the curves together can be used to predict the operating point of the pump and its energy consumption at different speeds. These qualities make knowledge of the system curve useful from the perspective of energy efficiency and condition monitoring.

A flow resistance of a system expressed by the system curve can be monitored to detect and measure fouling and clogging phenomena in systems that are subject to them. Constant monitoring of the system flow resistance can enable estimation of the energy lost through the fouling-induced extra flow resistance. Imminent clogging can also potentially be detected before the problem goes as far as to cause an unplanned and costly stoppage. It can also be possible to detect leaks as an unexpected decrease in the observed flow resistance coefficient.

Furthermore, knowledge of the system curve can also be useful when energy saving actions in a pump system are considered. Since the system curve can be used to predict pump performance at different rotational speeds, alternative, more energy-efficient variable-speed control schemes for the pump can be evaluated. With the help of the system curve, performance with alternative pumps, or with a trimmed impeller, can also be estimated.

Monitoring a flow resistance of a heat exchanger that builds up contaminants from the flow over time has traditionally required measurement instrumentation for generating relevant information. Such instrumentation carries an extra cost and may not be readily available in all locations where observing the system curve could help detect and measure phenomena that affect the energy efficiency and reliability of pumping processes.

There are some known sensorless methods for estimating system curves for pump assemblies. These known sensorless methods require identification run sequences during which the pump operating point is estimated and recorded, and the system curve is derived from the recorded data. The identification run sequences comprise specific control sequences controlling the pump assembly.

One of the problems associated with the known sensorless methods for estimating system curves is that most practical pump assemblies cannot be expected to allow for the execution of the identification run sequences, which alter control logic of the process. In connection with condition monitoring, using identification run sequences for estimating system curves of the pump assembly is especially problematic since a plurality of estimated system curves is required over time in order to detect a change in an operating state of the pump assembly.

### SUMMARY

An object of the present invention is to provide a condition monitoring method and a power converter system for implementing the method so as to solve the above problems. The objects of the invention are achieved by a condition monitoring method and a power converter system described in the following.

The invention is based on the idea of detecting a change in an operating state of the pump assembly by determining operating point data during normal operation of the pump assembly, and fitting estimated system curves on the operating point data, wherein said curve fitting is carried out for a plurality of fitting time windows over a long period of time. In other words, a large number of system curves is estimated for the pump assembly over a long period of time in order to detect a change in an operating state of the pump assembly for assessing whether the pump assembly requires maintenance.

An advantage of the condition monitoring method according to the invention is that no separate measurement instrumentation is required for estimating operating states of the pump assembly. Simply two instantaneous performance variables of the pump are needed along with two characteristic performance curves of the pump, the former ones being in many embodiments obtainable from signals of a variable speed drive adapted to actuate the pump, and the latter ones being typically readily available from a manufacturer of the pump.

### BRIEF DESCRIPTION OF THE DRAWINGS

In the following the invention will be described in greater detail by means of preferred embodiments with reference to the attached drawings, in which

FIG. 1 shows a simplified schematic of a pump assembly according to an embodiment of the invention;

FIGS. 2A and 2B illustrate estimating operating point data for a pump based on characteristic performance curves of the pump and instantaneous performance variables of the pump;

FIG. 3 illustrates how an operating point of a pump is located at an intersection of a characteristic performance curve of the pump and a system curve of the pump assembly; and

FIG. 4 is a flow chart illustrating a curve fitting procedure used in an embodiment of the invention.

### DETAILED DESCRIPTION OF THE INVENTION

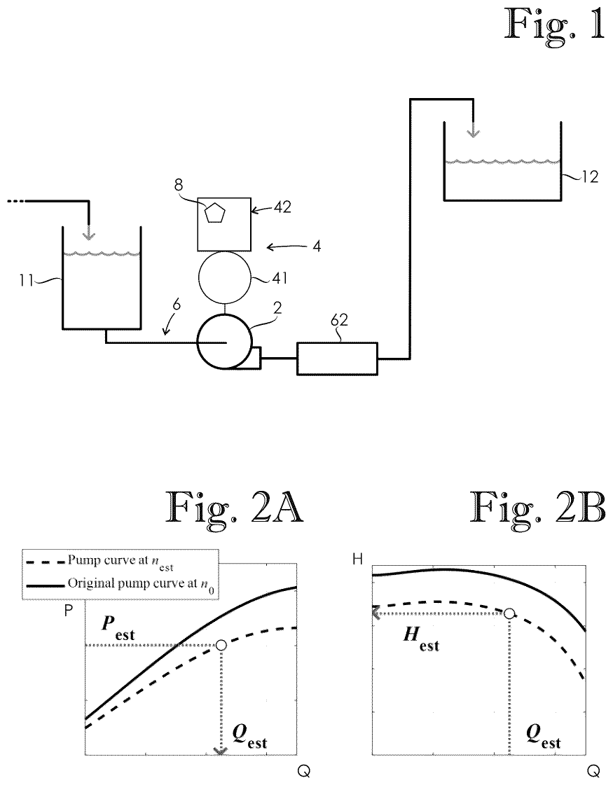

FIG. 1 shows a simplified schematic of a pump assembly comprising a first reservoir 11, a second reservoir 12, a pump 2, a variable speed drive 4 adapted to actuate the pump 2, a control system 8 adapted to control the variable speed drive 4, and a flow system 6 fluid communicatively connected to the pump 2. The pump 2 is adapted to move fluid from the first reservoir 11 to the second reservoir 12 through the flow system 6. The variable speed drive 4 comprises an electric motor 41 connected to the pump 2, and a frequency converter 42 adapted to supply power to the electric motor. The flow system 6 comprises a filter device 62 adapted to separate solid matter from the fluid.

A method for estimating a system curve for the pump assembly shown in FIG. 1 comprises: determining at least two characteristic performance curves of the pump 2; estimating at least two instantaneous performance variables of the pump 2 for a plurality of operating points of the pump assembly; determining operating point data for the pump assembly based on the at least two characteristic performance curves of the pump 2 and the estimated instantaneous performance variables of the pump 2, the operating point data comprising an estimated flow rate Qₑₛₜ and an estimated head Hₑₛₜ for the plurality of operating points of the pump assembly; and estimating the system curve for the pump assembly based on the operating point data, wherein the operating point data is determined during normal operation of the pump assembly, and the method comprises a curve fitting procedure, in which estimated system curves are fitted on the operating point data.

In an embodiment, the at least two characteristic performance curves of the pump are determined by acquiring the characteristic performance curves from a manufacturer of the pump. Typically, the characteristic performance curves of the pump acquired from a manufacturer of the pump are QP and QH curves, examples of which are shown in FIGS. 2A and 2B. Alternatively, the at least two characteristic performance curves of the pump are determined by some other way which does not require measurements made using flow sensors and/or pressure sensors. Also in this alternative embodiment, the at least two characteristic performance curves of the pump typically comprise QP and QH curves of the pump.

Characteristic performance curves of a pump are typically available for the nominal rotational speed of the pump. To estimate operating points of the pump for rotational speeds other than the nominal rotational speed, the characteristic performance curves for the nominal rotational speed must be converted to characteristic performance curves for instantaneous rotational speed using the following pump affinity laws:

$$Q = \frac{n}{{n}_{0}} {Q}_{0}$$

$$H = {( \frac{n}{{n}_{0}} )}^{2} {H}_{0}$$

$$P = {( \frac{n}{{n}_{0}} )}^{3} {P}_{0}$$

In the above equations no is the nominal rotational speed of the pump, n is instantaneous rotational speed of the pump, Q₀ is the flow rate for the nominal rotational speed of the pump, H₀ is the head for the nominal rotational speed of the pump, and P₀ is the nominal shaft power for the nominal rotational speed of the pump.

FIGS. 2A and 2B illustrate estimating operating point data for a pump based on characteristic performance curves of the pump and instantaneous performance variables of the pump. The instantaneous performance variables of the pump comprise an estimated rotational speed nest of the pump and an estimated shaft power Pₑₛₜ of the pump. The control system is adapted to determine the estimated rotational speed nest of the pump and the estimated shaft power Pₑₛₜ of the pump based on data relating to operation of the frequency converter. The data relating to operation of the frequency converter comprise currents and voltages of the frequency converter in vector form.

In an alternative embodiment, the instantaneous performance variables of the pump comprise an estimated rotational speed of the pump and an estimated shaft torque of the pump.

In an embodiment, the instantaneous performance variables of the pump are defined based on signals of the variable speed drive adapted to actuate the pump. In a further embodiment, where signals of the variable speed drive relating to the instantaneous performance variables of the pump comprise noise, the instantaneous performance variables of the pump are defined based on low-pass filtered signals of the variable speed drive.

FIG. 2A shows QP curves and FIG. 2B shows QH curves. Both FIGS. 2A and 2B show two curves, wherein an unbroken curve represents a characteristic performance curve of the pump at a nominal rotational speed no, and a broken curve represents an estimated characteristic performance curve of the pump at an estimated rotational speed nest.

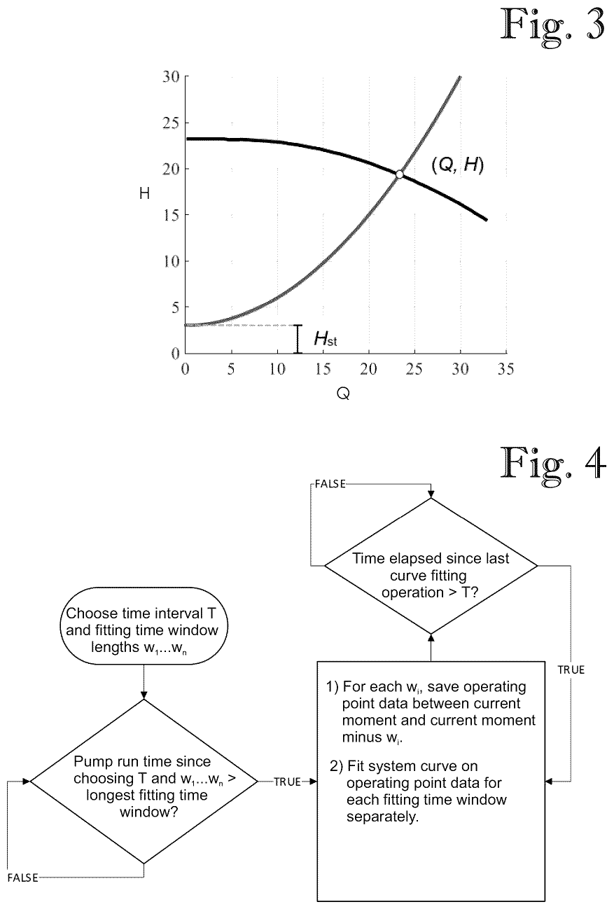

FIG. 3 illustrates how an operating point of a pump is located at an intersection of the characteristic QH curve of the pump and the system curve of the pump assembly. The shape of the QH curve of the system is defined by the flow resistance of the flow system as well as the static pressure difference between the suction and discharge sides of the pump. A system curve of a pump assembly can be expressed as a polynomial curve

H=kQ²+Hₛₜ,

where k is the flow resistance factor of the flow system, representing the sum of all the flow-resisting components in the way of the flow, and Hₛₜ is the static head of the flow system.

When the rotational speed of a pump is varied, its QH operating point moves along the system curve. Given that the flow system of the pump assembly remains constant during this speed change, the flow resistance k and static head Hₛₜ can be estimated by fitting the above defined system curve on operating point data using the least-squares method.

The curve fitting procedure comprises providing estimated system curves for a plurality of fitting time windows. Each of the plurality of fitting time windows comprises a plurality of operating points of the pump assembly. In an embodiment, the plurality of fitting time windows comprises overlapping fitting time windows. In an alternative embodiment, the fitting time windows do not overlap.

Curve fitting as such is a known process, and it is not described in detail herein.

An optimal length for fitting time windows depends on the pump assembly. In an embodiment, a length of each of the fitting time windows is in a range of 30 s to 48 hours. In another embodiment, a length of each of the fitting time windows is in a range of 1 minute to 24 hours.

In an embodiment, lengths for fitting time windows are determined by an equation I_{w}=15 min·2^{N}, wherein N is an index of the fitting time window and starts from zero. If four fitting time windows are used in this embodiment, N has values 0, 1, 2 and 3, and lengths of the fitting time windows are 15 min, min, 1 hour and 2 hours.

In the curve fitting procedure, system curves are fitted on operating point data using certain fitting time windows, and at certain time intervals T. FIG. 4 is a flow chart illustrating a curve fitting procedure of an embodiment of the invention.

In an embodiment utilizing the flow chart of FIG. 4, the time interval T is one minute, and there are three fitting time windows denoted by w1, w2 and w3. Length of the fitting time windows are w1=10 min, w2=20 min and w3=30 min. The process starts at t=0. The longest fitting time windows is w3 whose length is 30 minutes. When pump run time exceeds 30 minutes, operating point data is saved for the fitting time windows w1, w2 and w3 such that operating point data for w1 is saved from period 20-30 min, operating point data for w2 is saved from period 10-30 min, and operating point data for w3 is saved from period 0-30 min. Estimated system curves are fitted on the operating point data of each of the fitting time windows w1, w2 and w3. For each of the fitting time windows, a corresponding estimated system curve is created by the curve fitting procedure.

The method shown in FIG. 4 continues such that operating point data is saved for the fitting time windows at time intervals defined by T. Therefore, when pump run time exceeds 31 minutes, operating point data is saved for the fitting time windows w1, w2 and w3 such that operating point data for w1 is saved from period 21-31 min, operating point data for w2 is saved from period 11-31 min, and operating point data for w3 is saved from period 1-31 min. An estimated system curve is created for each fitting time window at time intervals defined by T, which in this example is one minute.

The time interval is shorter than the shortest of the fitting time windows. In an embodiment, a length of the time interval is in a range of 30 seconds to 5 minutes.

In an embodiment, the method comprises determining at least one estimation parameter for each fitting time window, and a filtering procedure for omitting unsuitable estimated system curves. The filtering procedure is adapted to identify the unsuitable estimated system curves based on at least one acceptance criterion, the at least one acceptance criterion comprising conditions for the at least one estimation parameter.

The at least one estimation parameter comprises at least one of the following: an estimated flow resistance factor k_{w} of the system, an estimated static head H_{st,w} of the system, a coefficient of determination R²_{w}, and a speed difference D_{s,w}, which is a difference between maximum and minimum speeds of the pump 2 in the fitting time window.

In an embodiment, the at least one estimation parameter comprises the estimated flow resistance factor k_{w} of the system, and the at least one acceptance criterion comprises a condition according to which the estimated flow resistance factor k_{w} of the system must be greater than zero. In another embodiment, the at least one estimation parameter comprises the coefficient of determination R²_{w}, and the at least one acceptance criterion comprises a condition according to which the coefficient of determination R²_{w} must be greater than a limit value for coefficient of determination, wherein the limit value for coefficient of determination is greater than or equal to 0.5. In a further embodiment, wherein the pump is a rotary pump, the at least one estimation parameter comprises the speed difference D_{s,w}, and the at least one acceptance criterion comprises a condition according to which the speed difference D_{s,w} is greater than or equal to 20 rpm.

The method according to the invention requires that the operating point data for the pump assembly is determined during normal operation of the pump assembly comprising a plurality of pump speeds.

The estimated flow resistance factor k_{w} of the system and/or the estimated static head H_{st,w} of the system are recorded for the fitting time windows whose estimated system curves pass the filtering procedure. In an embodiment, also start time and length of each of the fitting time windows are recorded.

In a condition monitoring method according to the invention, the curve fitting procedure comprises providing estimated system curves for a plurality of fitting time windows, wherein each of the plurality of fitting time windows comprises a plurality of operating points of the pump assembly. The plurality of fitting time windows is provided over a long period of time in order to detect a change in an operating state of the pump assembly for assessing whether the pump assembly requires maintenance.

In an embodiment, said change in an operating state of the pump assembly comprises a change in a value of the estimated flow resistance factor k_{w} of the system. In this embodiment, the pump assembly is interpreted to require maintenance when a value of the estimated flow resistance factor k_{w} of the system reaches a predetermined limit value. The predetermined limit value is greater than or equal to 1.5×k_{w0}, wherein k_{w0} is a reference value for the estimated flow resistance factor obtained when the pump assembly is new or recently cleaned. In an alternative embodiment, the predetermined limit value is greater than or equal to 1.25×k_{w0}.

In an embodiment, the long period of time over which the plurality of fitting time windows is provided is at least one week. In an alternative embodiment, the long period is at least one month. Further, it is possible to provide estimated system curves continuously during operation of the pump assembly, in which case the maximum value for the long period of time would be the operating life of the pump assembly.

When a filter device of the pump assembly is replaced, and/or a flow system of the pump assembly is cleaned, a flow resistance factor of the system decreases. In an embodiment of the condition monitoring method, a baseline flow resistance coefficient k₀ is determined after replacing a filter device of the pump assembly and/or cleaning a flow system of the pump assembly. Subsequent to determining a new baseline flow resistance coefficient, estimated flow resistance coefficients of the system are compared to the new baseline flow resistance coefficient in order to detect a change in an operating state of the pump assembly.

By monitoring value of the estimated flow resistance factor k_{w} of the system, cost-effective time for a maintenance operation of the pump assembly can be determined. Moreover, in systems where a gradual increase of system flow resistance is not normal, but where a build-up of solid material in the way of the flow is still a threat, the presented method can detect a rising trend in the estimated flow resistance factor and thereby provide an alert before total clogging and choking of the flow.

In an embodiment, a condition monitoring method comprises notifying operating personnel of the pump assembly when the pump assembly requires maintenance. Based on the notifications provided by the condition monitoring method, the operating personnel can carry out maintenance measures for the pump assembly at cost-effective intervals.

The condition monitoring method according to present invention can also be used to detect a decrease in the flow resistance factor of the system, which can be an indication of a leakage.

In a typical embodiment, the condition monitoring method according to the present invention is a computer implemented method.

In the pump assembly of FIG. 1, the variable speed drive 4 comprises the frequency converter 42. In an alternative embodiment, the variable speed drive comprises another type of power converter such as a DC to DC converter.

The control system 8 is adapted to estimate the at least two instantaneous performance variables of the pump 2 for the plurality of operating points of the pump assembly based on data relating to operation of the frequency converter 42. The data relating to operation of the frequency converter 42 comprises power supplied to the electric motor 41, and rotational speed of the motor 41. Rotational speed of the pump 2 can be determined based on the rotational speed of the motor 41.

The control system 8 is part of the frequency converter 42. In an alternative embodiment, the control system is not part of the power converter of the variable speed drive.

It will be obvious to a person skilled in the art that the inventive concept can be implemented in various ways. The invention and its embodiments are not limited to the examples described above but may vary within the scope of the claims.

1. A condition monitoring method for a pump assembly, the pump assembly comprising a pump, a variable speed drive adapted to actuate the pump, and a flow system fluid communicatively connected to the pump, wherein the method comprises:
determining at least two characteristic performance curves of the pump;
estimating at least two instantaneous performance variables of the pump for a plurality of operating points of the pump assembly;
determining operating point data for the pump assembly based on the at least two characteristic performance curves of the pump and the estimated instantaneous performance variables of the pump, the operating point data comprising an estimated flow rate and an estimated head for the plurality of operating points of the pump assembly; and
estimating the system curve for the pump assembly based on the operating point data,
wherein the operating point data is determined during normal operation of the pump assembly, and the method includes a curve fitting procedure, in which estimated system curves are fitted on the operating point data,
wherein the curve fitting procedure includes providing estimated system curves for a plurality of fitting time windows, wherein each of the plurality of fitting time windows includes a plurality of operating points of the pump assembly,
wherein the plurality of fitting time windows is provided over a long period of time in order to detect a change in an operating state of the pump assembly for assessing whether the pump assembly requires maintenance.

2. The method according to claim 1, wherein the method comprises determining at least one estimation parameter for each fitting time window, and a filtering procedure for omitting unsuitable estimated system curves, wherein the filtering procedure is adapted to identify the unsuitable estimated system curves based on at least one acceptance criterion, the at least one acceptance criterion including conditions for the at least one estimation parameter.

3. The method according to claim 2, wherein the at least one estimation parameter comprises at least one of the following: an estimated flow resistance factor of the system, an estimated static head of the system, a coefficient of determination, and a speed difference, which is a difference between maximum and minimum speeds of the pump in the fitting time window.

4. The method according to claim 3, wherein the at least one estimation parameter comprises the estimated flow resistance factor of the system, and the at least one acceptance criterion includes a condition according to which the estimated flow resistance factor of the system must be greater than zero.

5. The method according to claim 3, wherein the at least one estimation parameter comprises the coefficient of determination, and the at least one acceptance criterion includes a condition according to which the coefficient of determination must be greater than a limit value for coefficient of determination.

6. The method according to claim 5, wherein the limit value for coefficient of determination is greater than or equal to 0.5.

7. The method according to claim 1, wherein the long period of time is at least one week.

8. The method according to claim 3, wherein the method comprises recording the estimated flow resistance factor of the system and/or the estimated static head of the system for the fitting time windows whose estimated system curves pass the filtering procedure.

9. The method according to claim 1, wherein the plurality of fitting time windows comprises overlapping fitting time windows.

10. The method according to claim 1, wherein a length of each of the fitting time windows is in a range of 30 s to 48 hours.

11. The method according to claim 1, wherein the method comprises notifying operating personnel of the pump assembly when the pump assembly requires maintenance.

12. The method according to claim 1, wherein said change in an operating state of the pump assembly comprises a change in a value of the estimated flow resistance factor of the system, wherein the pump assembly is interpreted to require maintenance when a value of the estimated flow resistance factor of the system reaches a predetermined limit value.

13. A power converter system for a pump assembly comprising:
a power converter adapted to supply power to an electric motor which is adapted to be connected to a pump; and
a control system adapted to control the power converter;
wherein the control system is adapted to carry out the condition monitoring method including the steps determining at least two characteristic performance curves of the pump;
estimating at least two instantaneous performance variables of the pump for a plurality of operating points of the pump assembly;
determining operating point data for the pump assembly based on the at least two characteristic performance curves of the pump and the estimated instantaneous performance variables of the pump, the operating point data comprising an estimated flow rate and an estimated head for the plurality of operating points of the pump assembly; and
estimating the system curve for the pump assembly based on the operating point data,
wherein the operating point data is determined during normal operation of the pump assembly, and the method includes a curve fitting procedure, in which estimated system curves are fitted on the operating point data,
wherein the curve fitting procedure includes providing estimated system curves for a plurality of fitting time windows, wherein each of the plurality of fitting time windows includes a plurality of operating points of the pump assembly,
wherein the plurality of fitting time windows is provided over a long period of time in order to detect a change in an operating state of the pump assembly for assessing whether the pump assembly requires maintenance.

14. The power converter system according to claim 13, wherein the power converter is a frequency converter.

15. The power converter system according to claim 14, wherein the control system is adapted to estimate the at least two instantaneous performance variables of the pump for the plurality of operating points of the pump assembly based on data relating to operation of the frequency converter.
